(19) United States
(12) Patent Application Publication
(10) Pub. No.: US 2026/0243668 A1
(43) Pub. Date: Aug. 20, 2026

(54) Standalone Passive Biomimetic Sensors

(71) Applicant: The Government of the United States of America, as represented by the Secretary of the Navy, Arlington, VA (US)

(72) Inventors: Cobey L. McGinnis, Springfield, VA (US); Kenneth J. Ewing, Edgewater, MD (US); Jeremiah N. Smith, Vienna, VA (US); Mauricio Perez-Oviedo, College Park, MD (US); Jasbinder S. Sanghera, Ashburn, VA (US)

(73) Assignee: The Government of the United States of America, as represented by the Secretary of the Navy, Arlington, VA (US)

(21) Appl. No.: 19/644,220

(22) Filed: Apr. 10, 2026

Related U.S. Application Data
(63) Continuation-in-part of application No. 19/390,826, filed on Nov. 17, 2025.
(60) Provisional application No. 63/813,159, filed on May 28, 2025.
(60) Provisional application No. 63/734,308, filed on Dec. 16, 2024.

(51) Int. Cl. G01N 21/3504; G01J 5/061

(52) U.S. Cl. CPC G01N 21/3504; G01J 5/061; G01J 2005/062; G01N 2201/068

(57) ABSTRACT

According to some embodiments of the present disclosure, a chemical vapor sensor is configured to detect a chemical analyte, and the chemical vapor sensor includes an enclosure, an infrared (IR) sensor in the enclosure, and a controller coupled with the IR sensor. The enclosure includes a transparent portion, and the transparent portion is transparent with respect to infrared radiation. The IR sensor is oriented to receive IR radiation incident thereon through the transparent portion of the enclosure, and the IR sensor is configured to generate signaling responsive to the IR radiation incident thereon. The controller is configured to detect the presence of the chemical analyte outside the enclosure responsive to the signaling from the IR sensor.

### CROSS-REFERENCE TO RELATED APPLICATIONS

This Application is a Nonprovisional Utility Patent Application and claims the benefit of priority under 35 U.S.C. Sec. 119 based on U.S. Provisional Patent Application No. 63/813,159 filed on May 28, 2025. This Application also claims the benefit of priority as a continuation-in-part of U.S. Application No. 19/390,826 filed on November 17, 2025, which claims the benefit of priority under 35 U.S.C. Sec. 119 based on U.S. Provisional Patent Application No. 63/734,308 filed on December 16, 2024. The disclosures of Provisional Application No. 63/813,159, Provisional Application No. 63/734,308, and U.S. Application No. 19/390,826, and all references cited herein are hereby incorporated in their entireties by reference into the present disclosure.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case # 212506.

### TECHNICAL FIELD

This disclosure relates to sensors, and more particularly, to biomimetic sensors and related methods.

### BACKGROUND OF THE INVENTION

Infrared spectroscopy is a technique that can be used to detect and identify the presence of hazardous chemicals (gas/vapor, liquid, and solid) based on their unique absorption bands in the infrared portion of the electromagnetic spectrum. This technique relies on collecting the intensity of transmitted or reflected light from a well-controlled and characterized infrared source, typically with the use of a detector cooled either thermoelectrically or with liquid nitrogen. There is a demand for these systems to operate and survive in different outdoor environmental conditions.

U.S. Patent Numbers 11,029,247 (issued June 8, 2021) and 9,857,295 (issued January 2, 2018) describe systems which detect infrared chemical signatures (either as a solid/liquid on a surface or as a vapor in the atmosphere) and methodologies to discriminate these chemical signatures using the Infrared CIE methodology (an infrared analog of the visible color space defined by the International Commission on Illumination). The disclosures of U.S. Patent Numbers 11,029,247 and 9,857,295 are hereby incorporated herein in their entireties by reference.

### SUMMARY OF THE INVENTION

This summary is intended to introduce in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of the present disclosure, a chemical vapor sensor is configured to detect a chemical analyte, and the chemical vapor sensor includes an enclosure, an infrared (IR) sensor in the enclosure, and a controller coupled with the IR sensor. The enclosure is configured so that a top of the enclosure is oriented up when the chemical vapor sensor is in use, and the top of the enclosure includes a transparent portion that is transparent with respect to infrared radiation. The IR sensor is oriented up when the chemical vapor sensor is in use to receive IR radiation incident thereon through the transparent portion of the top of the enclosure, and the IR sensor is configured to generate signaling responsive to the IR radiation incident thereon. The controller is configured to detect the presence of the chemical analyte outside the enclosure responsive to the signaling from the IR sensor.

According to some other embodiments of inventive concepts, a chemical vapor sensor is configured to detect a chemical analyte, and the chemical vapor sensor includes an enclosure, a gas flow path through the enclosure, an internal infrared (IR) standard, and IR sensor, and a controller coupled with the IR sensor. The enclosure includes first and second ports to an outside environment, the gas flow path is provided through the enclosure between the first and second ports, and the gas flow path includes an IR transparent material. The internal IR standard is on a first side of the IR transparent material of the gas flow path, and the internal IR standard is configured to provide a stable IR background. The IR sensor is on a second side of the IR transparent material of the gas flow path, and the IR transparent material of the gas flow path is between the internal IR standard and the IR sensor. The IR transparent material of the gas flow path provides an IR transmission path through the gas flow path between the internal standard and the IR sensor, and the IR sensor is configured to generate signaling responsive to IR radiation incident thereon. The controller is configured to detect the presence of the chemical analyte in the gas cell responsive to the signaling from the IR sensor.

According to still other embodiments of inventive concepts, a chemical vapor sensor is configured to detect a chemical analyte, and the chemical vapor sensor includes an enclosure, an infrared (IR) sensor in the enclosure, and a controller coupled with the IR sensor. The enclosure includes a transparent portion, and the transparent portion is transparent with respect to IR radiation. The IR sensor is oriented to receive IR radiation incident thereon through the transparent portion of the enclosure, and the IR sensor is configured to generate signaling responsive to the IR radiation incident thereon. The controller is configured to detect the presence of the chemical analyte outside the enclosure responsive to the signaling from the IR sensor.

### BRIEF DESCRIPTION OF DRAWINGS

Examples of embodiments of inventive concepts may be more clearly understood from the following detailed description taken in conjunction with the accompanying drawings in which:

FIGS. 1A-1, 1A-2, 1A-3, and 1A-4 illustrate respective top, side, front, and back views of a ruggedized standalone passive biomimetic sensor system according to some embodiments of inventive concepts.

FIGS. 1B provides a transparent view showing internal systems and configurations of a ruggedized stand-alone PBS system according to some embodiments of inventive concepts.

FIGS. 2A and 2B are block diagrams illustrating internal systems and configurations of the ruggedized stand-alone passive biomimetic sensor system of FIGS. 1A-1, 1A-2, 1A-3, and 1B according to some embodiments of inventive concepts.

FIGS. 3A, 3B, and 3C illustrate curved/convex dome surfaces with IR transparent windows/lenses at the apex of the dome for hardened enclosed PBS systems according to some embodiments of inventive concepts.

FIGS. 4A and 4B are block diagrams illustrating Internal elements of a hardened PBS system that uses the flow from one or more electronic fans to guide external vapors into a gas cell to be detected against an internal standard according to some embodiments of inventive concepts.

FIG. 4C is a block diagram illustrating the internal standard of FIGS. 4A and 4B according to some embodiments of inventive concepts.

### DETAILED DESCRIPTION OF THE INVENTION

Aspects and features of the present disclosure will now be described more fully with reference to the accompanying drawings. The following description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, like reference numerals refer to like elements throughout, and sizes of each of the elements may be exaggerated for clarity and convenience of explanation.

According to some embodiments of inventive concepts, a Passive Biomimetic Sensor (PBS) system may monitor for the presence of hazardous chemical vapor releases in outdoor environments. Therefore, such systems may desirably be ruggedized to survive in multiple different weather conditions and/or to provide operation that is relatively unaffected by dirt/debris blown by the wind. In the following disclosure, enclosures are provided to house PBS systems.

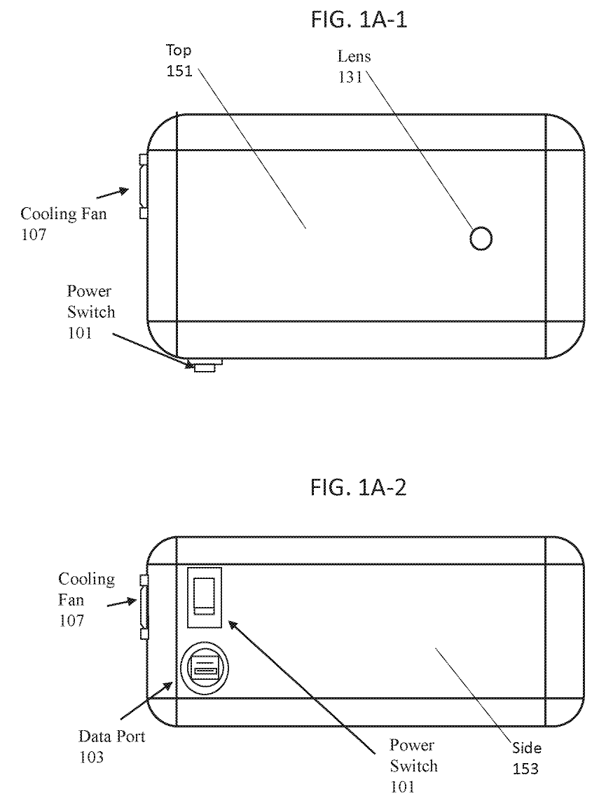

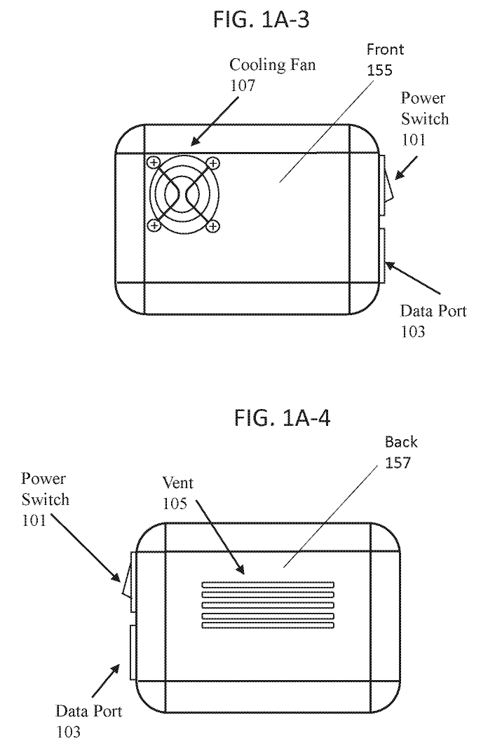

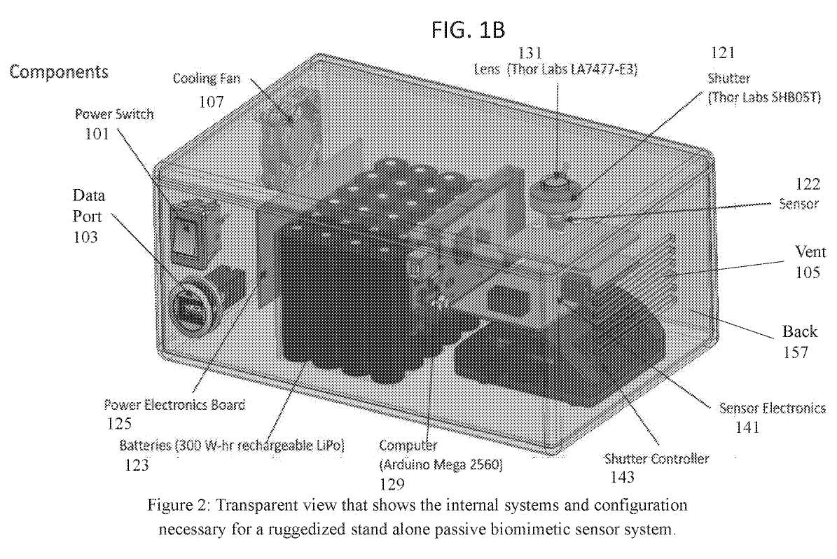

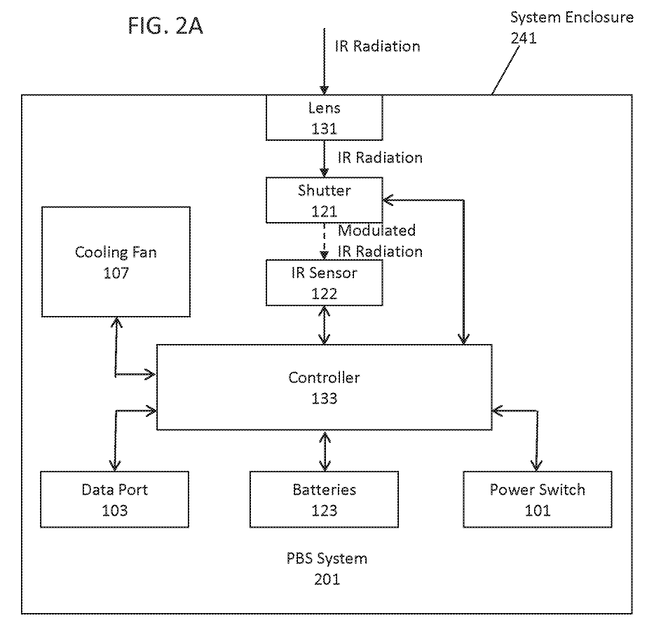

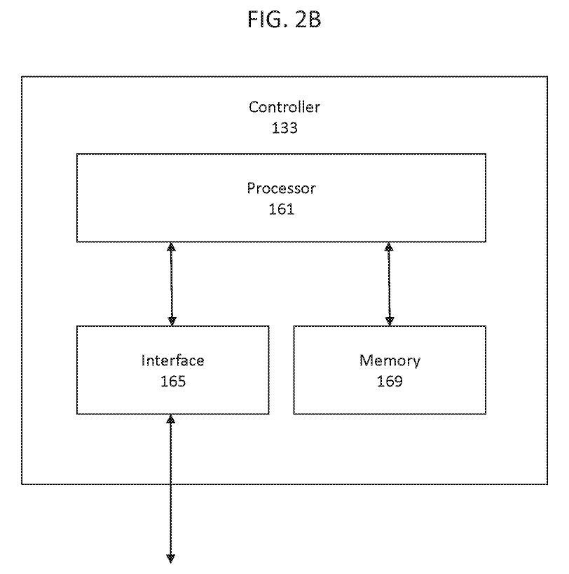

According to some embodiments of inventive concepts, a PBS system is enclosed in a polymer housing to protect the internal hardware components as shown in FIGS. 1A-1, 1A-2, 1A-3, 1A-4, and 1B. This enclosure may include: power switch 101 (also referred to as an on/off switch) and data port 103 (e.g., a Universal Serial Bus USB and/or Secure Digital SD port) on side 153; vent 105 on back 157 to exhaust/remove excess heat (shown in FIG. 1B); fan 107 on front 155 to cool the pyroelectric detector (e.g., blowing air through the enclosure and out vent 105); and lens 131 on top 151. Electronic boards/modules included inside the enclosure may provide computer 129, power electronics board 125, sensor electronics 141, and shutter controller 143. These electronics boards/modules may together provide controller 133 (discussed in greater detail below with respect to FIGS. 2A and 2B) to control operation of the pyroelectric detector, including control of mechanical shutter 121, power supply (e.g., including batteries 123), data conversion, and fan 107, and to process signals from sensor 122 to determine the presence or absence of a chemical. Batteries 123 may provide a rechargeable power source to maintain extended operation of the system outdoors. Computer 129 may be coupled with port 103 (e.g., either USB or SD), and local storage/memory of computer 129 may store information recorded by the pyroelectric detector and/or perform data analysis. This platform may protect components of the PBS system from external inclement weather conditions and/or dirt/debris. This may allow the PBS system to remotely monitor for chemical releases over an extended period of time.

FIG. 1B is a transparent view of the system discussed above with respect to FIGS. 1A-1, 1A-2, and 1A-3. Front 155 of FIG. 1A-3 (with cooling fan 107) is shown to the left in FIG. 1B. Side 153 of FIG. 1A-2 is shown facing out of the view of FIG. 1B. Back 157 (including vent 105) is shown to the right in FIG. 1B. Top 151 of FIG. 1A-1 is shown to the top of FIG. 1B. A second side (opposite side 153) and a bottom (opposite top 151) complete the enclosure. While not explicitly shown in FIGS. 1A-1, 1A-2, 1A-3, 1A-4, and 1B, filters may be provided at ports for fan 107 and/or vent 105 to reduce introduction of dust, debris, and/or interferents into enclosure 241.

FIG. 2A is a schematic block diagram illustrating elements of PBS system 201 including power switch 101, batteries 123, data port 103, cooling fan 107, shutter 121, sensor 122, lens 131, and controller 133. In FIG. 2A, controller 133 may provide operations discussed herein with respect to electronic boards/modules including controlling operation of the detector, performing data conversion, controlling fan 107, controlling charging of batteries 123, controlling distribution of power from batteries 123, transferring data to/from data port 103, storing information generated by the sensor 122, analyzing data generated by sensor 122, controlling shutter 121, receiving signaling from sensor 122, processing signaling from sensor 122 to determine the presence/absence of a chemical, turning on/off responsive to input from power switch 101, etc.

FIG. 2B is a block diagram illustrating controller 133 of FIG. 2A. Controller 151 may include processor 161 (also referred to as processor circuitry), interface 165 (also referred to as interface circuitry) coupled with processor 161, and memory 169 (also referred to as memory circuitry) coupled with processor 161. Interface 165 may be configured to couple signaling between processor 161 and each of: power switch 101; data port 103; cooling fan 107; sensor 122; shutter 121; and/or batteries 123. Memory 169 includes computer readable program code that when executed by processor 161 causes processor 161 to perform operations according to embodiments disclosed herein. Memory 169 may also be used to store information based on signaling from sensor 122, including information used by processor 161 to determine the presence/absence of a chemical and/or information indicating the presence/absence of the chemical. According to other embodiments, processor 161 may be defined to include memory so that a separate memory is not required. Accordingly, processor 161 of controller 151 is configured to transmit control signaling through interface circuitry 165, to control shutter 121, to receive signaling from sensor 122, and to determine whether a particular chemical is present based on the signaling from sensor 122.

Many different embodiments may exist to construct a hardened fully housed passive biomimetic sensor system. Common features shared between some embodiments may include a polymer housing that is resistant to external weather conditions, a system (e.g., including fan 107 and/or vents 105) to cool the inside of the housing, an external and/or internal power supply, internal storage (e.g., memory 169) for the information measured by the pyroelectric detector, and a vent 105 to induce airflow out of the housing. According to some embodiments, the housing is designed such that the pyroelectric detector’s field of view is filled by an appropriate IR source such as the cold sky or a blackbody source. If a chemical vapor of interest then passes within the detector’s field of view between the PBS system and the IR source, processor 161 can determine the presence of the chemical vapor of interest based on signaling from sensor 122. The housing and internal hardware components allow the system to operate independently of external computers, external power sources, and/or human interaction and so that the system can monitor for chemical vapor releases over an extended period of time.

In some embodiments of inventive concepts, a polymer (ABS) hard casing encloses the full PBS system. The polymer hard casing can be approximately 10 inches x 6 inches x 4 inches in size (e.g., see FIGS. 1A-1, 1A-2, 1A-3, and 1B). This casing is equipped with an electrically operated fan 107 on one end (e.g., front 155) to move cool air through the enclosure to keep the internal temperature of the enclosure regulated and a vent 105 on the opposite end (e.g., back 157) to allow warm air to flow out. An awning may be placed over the fan port to stop/reduce water from being pulled into the fan 107 while allowing air to still flow through/over the PBS system. Power switch 101 and data port (e.g., a USB/SD data port) are located on one side of the enclosure to enable the system to be turned on and off, and to facilitate off-loading of data collected by the PBS system, respectively. A ZnSe lens 131 is mounted in the enclosure such that thermal radiation from the background and chemical vapor of interest are focused through shutter 121 onto sensor 122 of the pyroelectric detector. Inside of the enclosure, controller 133 (e.g., implemented using one or more electronics board/boards including computer 129) is provided to control and operate mechanical shutter 121, and two electronics boards of controller 133 may be provided to control the detector and to process and store the data collected by the detector, respectively. An internal power supply (e.g., including batteries 123) is also mounted inside the polymer hard case to provide remote operation of the PBS system. The enclosure protects the PBS system from different weather conditions, and the enclosure also stops/reduces dirt/debris from being blown onto the operational components of the PBS system. This allows the PBS system to continuously monitor for chemical releases over variable environmental conditions.

In some embodiments of inventive concepts, the ZnSe lens may be replaced with a lens comprising a different IR transmitting material such as, but not limited to, yttrium oxide, magnesium fluoride (IRTRAN1), magnesium oxide (IRTRAN5), or other mid, to long-wavelength IR transmitting material.

In some embodiments of inventive concepts, the enclosure may be fitted with an IR transmitting window hydrophobically modified such that any water contacting the hydrophobic surface of the lens is repelled by the hydrophobic surface so that the water physically leaves the window surface. This may reduce interference caused by liquid water with respect to measurements made by the PBS system.

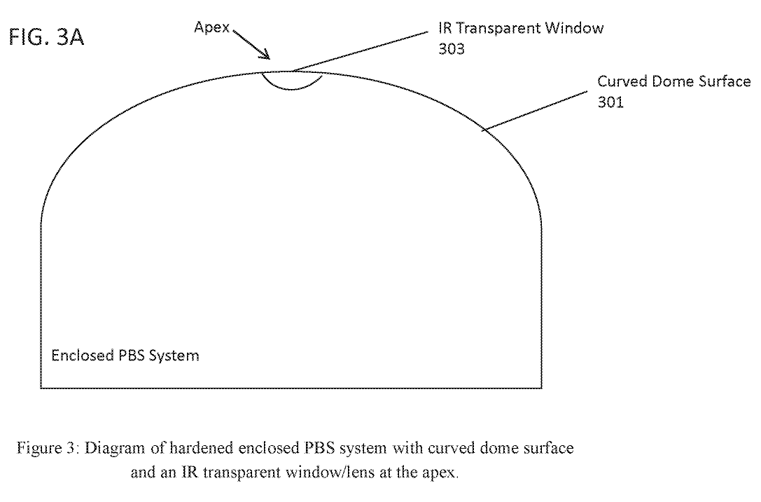

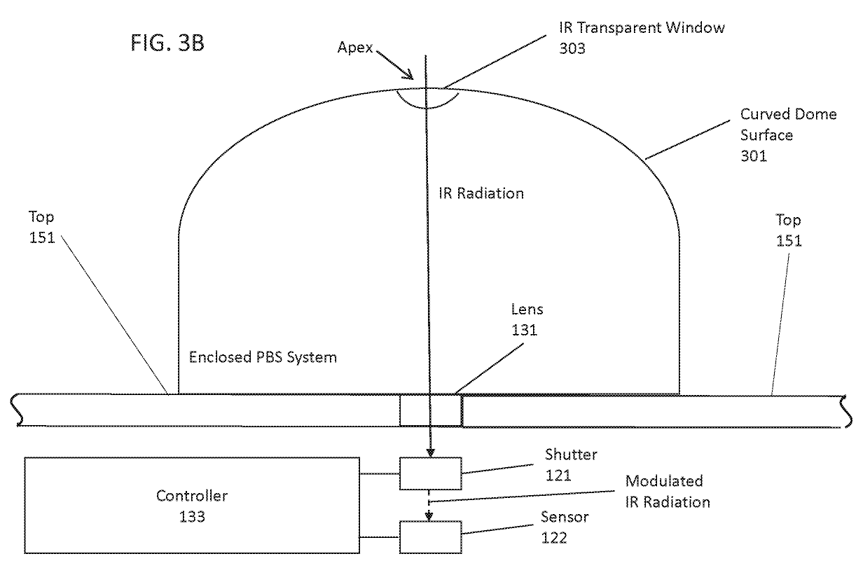

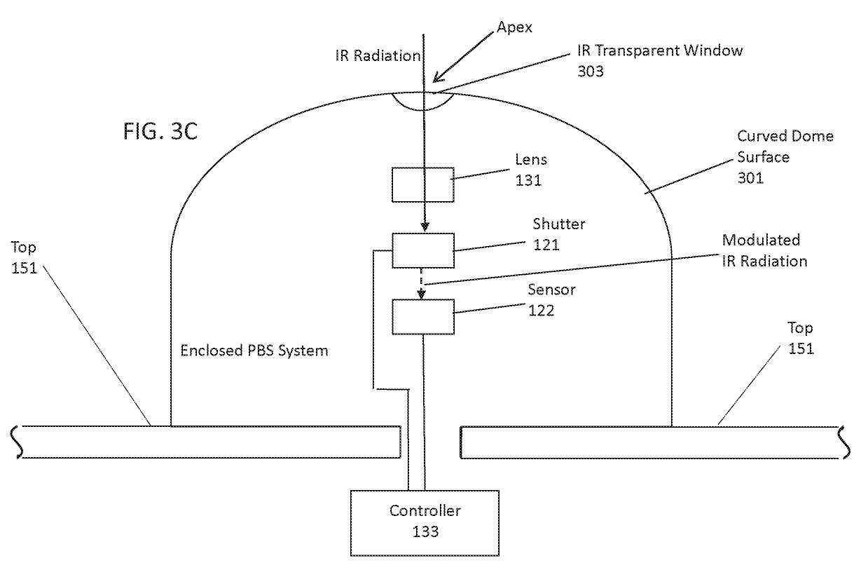

In some embodiments of inventive concepts, the top of the enclosure may be convex like a dome with an IR transparent window/lens at the apex as shown in FIGS. 3A, 3B, and 3C. This curved surface and window/lens can be treated to impart hydrophobic behavior. The curvature of this surface and window/lens may reduce/prevent piling up of dirt, debris, water and/or snow on the exit optical aperture.

In FIG. 3A, curved dome surface 301 with IR transparent window 303 may be provided on top 151 of the system of FIGS. 1A-C and 2A-C over lens 131 according to some embodiments of inventive concepts. According to some embodiments, lens 131 may be integrated with top 151, and curved dome surface 301 may be provided on top 151 as shown in FIG. 3B. In FIG. 3B, IR transparent window 303 and lens 131 are oriented toward the sky which acts as controlled IR background. IR radiation thus passes through window 303, lens 131, and shutter 121. Lens 131 focuses the IR radiation, shutter 121 modulates the IR radiation responsive to control signaling from controller 133, the modulated IR radiation is focused on sensor 122, sensor 122 generates signaling responsive to the modulated IR radiation, and this signaling from sensor 122 is used by controller 133 to determine whether a particular chemical analyte is present in the path of IR radiation outside the system (i.e., between IR transparent window 303 and the sky).

According to some other embodiments shown in FIG. 3C, one or more of lens 131, shutter 121, and/or sensor 122 may be provided within the dome above top 151. According to still other embodiments, lens 131 may be provided in place of window 303 at the apex of the dome so that a separate window is not used. According to yet other embodiments, curved dome surface 301 may be provided as top 151 of the enclosure. IR transparent window 303 may have a hydrophobic surface to repel water, or if lens 131 is provided without a separate window, lens 131 may have a hydrophobic surface to repel water. A hydrophobic surface may be provided, for example, as a hydrophobic film on the window/lens. According to still other embodiments, one or both of shutter 121 and sensor 122 may be provided beneath top 151 as shown in FIG. 3B, and lens 131 may be provided in dome 301 as shown in FIG. 3C or in place of window 303 as discussed above.

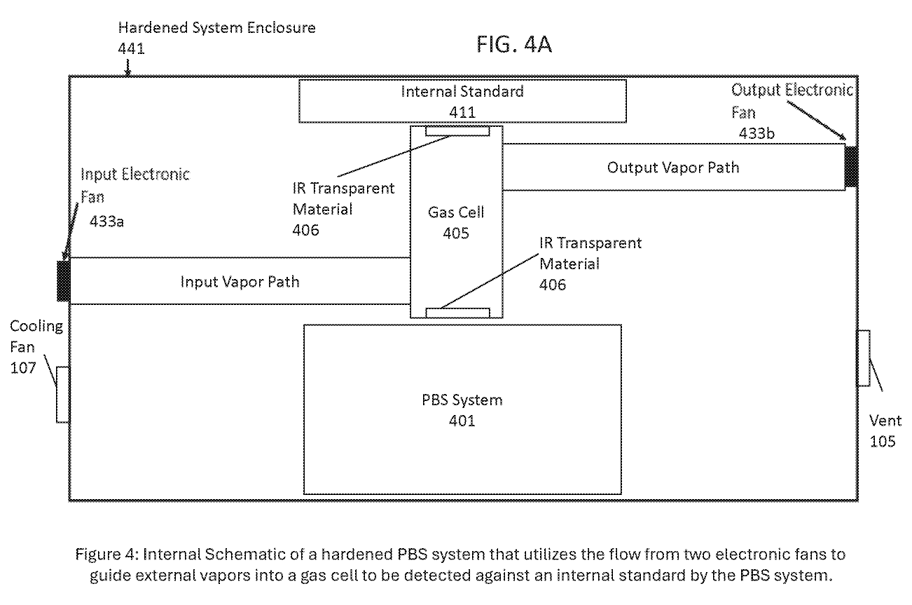

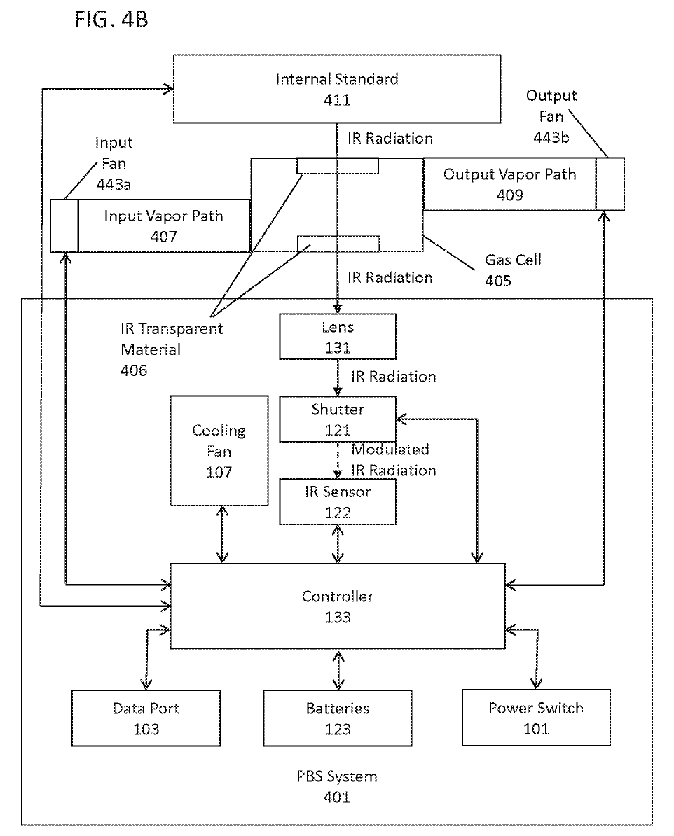

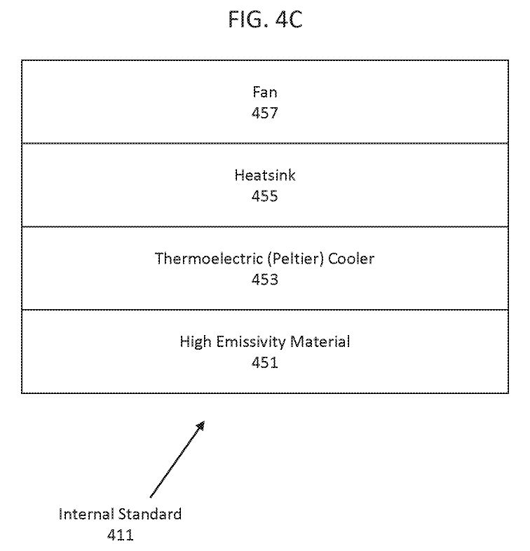

In some embodiments of inventive concepts shown in FIGS. 4A and 4B, electric fan/fans 443a/443b on the enclosure push/pull chemical vapors through gas cell 405 within the enclosure. Gas cell 405 is within the field of view of lens 131 of PBS system 401. Internal standard 411 (such as an IR source) is placed behind gas cell 405 providing a cold stop to give PBS system 401 a clear view of the cold stop. This allows PBS system 401 to detect/discriminate target chemical vapors with a well-controlled stable IR background rather than a variable sky (i.e., clear versus cloudy sky).

Input vapor path 407 (e.g., a first tube) provides a path for gas to flow from outside the enclosure to gas cell 405, and output vapor path 409 (e.g., a second tube) provides a path for gas to flow from gas cell 405 to outside the enclosure. For example, input fan 443a may push vapor from outside the enclosure through input vapor path 407, gas cell 405, and output vapor path 409 to outside the enclosure, and/or output fan 443b may pull vapor from output vapor path 409, gas cell 405, and input vapor path 407 to outside the enclosure. Moreover, gas cell 405 may include an IR transparent material allowing passage of IR radiation therethrough. Input vapor path 407, gas cell 405, and output vapor path 409 may thus provide an enclosed path within the system enclosure. According to some embodiments of inventive concepts, IR transparent material 406 may be provided as IR transparent windows on opposite sides of gas cell 405. According to some other embodiments of inventive concepts, gas cell 405 may be formed entirely from the IR transparent material.

As shown in FIG. 4B, PBS system 401 may include power switch, data port 103, batteries 123, controller 133, cooling fan 107, IR sensor 122, shutter 121, and lens 131, and these elements may be provided as discussed above with respect to FIG. 2A. Moreover, controller 133 of FIG. 4B may be provided as discussed above with respect to FIG. 2B. In addition, controller 133 may control internal standard 411, input fan 443a and/or output fan 443b via signaling from interface 165.

As shown in FIG. 4C, internal standard 411 may include high emissivity material 451, thermoelectric (Peltier) cooler 453 (also referred to as a TE cooler), heatsink 455, and fan 457 according to some embodiments of inventive concepts. TE cooler 453 may be controlled by controller 133 to maintain a desired temperature of high emissivity material and provide a stable IR background for chemical vapor detection. Accordingly, TE cooler 453 may pump heat from high emissivity material 451 to heatsink 455, and fan 457 may provide cooling of heatsink 455. While a separate fan 457 is shown for internal standard 411 by way of example, cooling fan 107 may provide sufficient cooling for internal standard 411 so that a separate fan is not needed. Use of thermoelectric coolers is discussed by way of example in U.S. Patent Application No. 19/390,826 entitled “Manufactured Controllable Cold Background for Passive Biomimetic Sensor” and filed November 17, 2025, and in U.S. Application No. 63/734,308 entitled “Manufactured Controllable Cold Background for Passive Biomimetic Sensor” filed December 16, 2024. The disclosures of both of these patent applications are hereby incorporated herein in their entireties by reference. Moreover, while not explicitly shown in FIGS. 4A, 4B, and 4C, filters may be provided at ports for cooling fan 107, vent 105, input fan 433a, and/or output fan to reduce introduction of dust, debris, and/or interferents into enclosure 441.

In some embodiments of inventive concepts, the material for the enclosure does not need to be a polymer but instead can be metallic or any other hardened material. The enclosure only needs to protect the optical, hardware, and software components of the PBS system from the external environment. In some embodiments of inventive concepts, a hardened material thus encloses the PBS system. This enclosure thus protects the components of the PBS system enabling detection/discrimination of chemical vapor agents released into the atmosphere under various operational conditions. The enclosure may include multiple vents (e.g., vent 105) to enable temperature control of the operational systems contained within the enclosure. Data is stored internally (e.g., in memory 169), and a rechargeable power source (e.g., batteries 123) may be housed within the enclosure.

Some embodiments of inventive concepts may include one or more of the elements discussed below.

According to some embodiments of inventive concepts, an assembly may include: an aperture shutter 121 to modulate the IR radiation signal; a ZnSe, or other infrared transmitting lens 131; and IR sensor 122 with multiple channels/pixels. Over each channel/pixel, a broad or narrow bandpass infrared IR optical filter may be provided. The transmission window for each IR optical filter is adjusted such that a multiplicity of IR optical filter transmission windows overlap IR absorption bands for a given chemical analyte or set of chemical analytes. A minimum of 1 IR optical filter transmits in the IR where absorption bands are not expected.

According to some embodiments of inventive concepts, a hardened material may enclose the PBS system to protect it from external conditions. The surface may have vents (e.g., vent 105) and fans (e.g., fan 107) to regulate internal temperature along with data ports (e.g., data port 103) to provide connection and removal of data.

According to some embodiments of inventive concepts, a method of forming a hardened assembly for chemical vapor detection/discrimination may include one or more of the following operations. A hardened enclosure may be fabricated either from a polymer or metal material. This enclosure should fully encapsulate the PBS system protecting it from external conditions. A passive biomimetic sensor system 401 may be fabricated by aligning mechanical shutter 121 with IR transmitting lens 131 such that emitted thermal radiation (collected from the exterior environment of FIGS. 1A-C and 2A-C or interior gas cell 405 of FIGS. 4A-B) is collected by lens 131, modulated by shutter 121, and projected onto IR sensor 122 (also referred to as an IR detector) outfitted with multiple channels/pixels. Each pixel/channel is outfitted with a different IR filter. A minimum of three broadband IR filters exhibit transmission windows which overlap. This enables the IR detector to measure the light over each wavelength range as determined by the broadband IR filters. An internal power supply (e.g., batteries 123) may provide extended operating time of the PBS system without requiring an external power source. Internal storage (e.g., memory 169) may be provided that can be accessed, for example, by external data port 103 (e.g., a USB or SD data port) and/or by a wireless interface (e.g., WiFi, Bluetooth, etc.).

Advantages and new features according to some embodiments of inventive concepts are discussed below.

According to some embodiments of inventive concepts, the detection/discrimination of chemical vapors from background interferents (e.g., water vapor and/or carbon dioxide) may be provided.

According to some embodiments of inventive concepts, the passive biomimetic sensor may provide operation in outdoor environments regardless of weather conditions.

According to some embodiments of inventive concepts, the PBS system may record information to internal data storage (e.g., memory 169) that can be easily retrieved.

According to some embodiments of inventive concepts, deployment and/or retrieval of the PBS system may be simplified.

According to some embodiments of inventive concepts, continuous monitoring of the environment for chemical vapors may be provided.

Alternatives according to some embodiments of inventive concepts are provided in the following disclosure.

According to some embodiments of inventive concepts, the enclosure may be provided using materials such as different polymers or metals (such as aluminum, steel, or copper).

According to some embodiments of inventive concepts, the system may include mechanisms to regulate the internal temperature of the sensor such as liquid and/or electronic cooling.

According to some embodiments of inventive concepts, wireless connection (e.g., Wi-Fi, Bluetooth, or RFID) may be provided to control the system and/or to retrieve information measured by the PBS system. In such embodiments, interface 165 may include a wireless interface (e.g., a Wi-Fi, Bluetooth, or RFID interface) in addition to or instead of data port 103.

According to some embodiments of inventive concepts, alternative power sourcing (such as hardwiring to a standard power source, solar, and/or wind) may be provided.

Additional examples of some embodiments of inventive concepts are discussed below. Reference numbers are provided in the following Embodiments only as examples illustrated in the figures without limiting the scope of the Embodiments.

Embodiment 1. A chemical vapor sensor configured to detect a chemical analyte, the chemical vapor sensor comprising: an enclosure (241) configured so that a top (151) of the enclosure is oriented up when the chemical vapor sensor is in use, and wherein the top of the enclosure includes a transparent portion, and wherein the transparent portion is transparent with respect to infrared radiation; an infrared (IR) sensor (122) in the enclosure (241) wherein the IR sensor is oriented up when the chemical vapor sensor is in use to receive IR radiation incident thereon through the transparent portion of the top of the enclosure, and wherein the IR sensor is configured to generate signaling responsive to the IR radiation incident thereon; and a controller (133) coupled with the IR sensor (122), wherein the controller (133) is configured to detect the presence of the chemical analyte outside the enclosure responsive to the signaling from the IR sensor.

Embodiment 2. The chemical vapor sensor of Embodiment 1, wherein the top of the enclosure includes a convex surface having an apex, and wherein the transparent portion of the enclosure is provided at the apex of the convex surface.

Embodiment 3. The chemical vapor sensor of any of Embodiment 1-2, wherein the transparent portion of the enclosure comprises a lens (131) configured to focus the IR radiation incident on the IR sensor (122).

Embodiment 4. The chemical vapor sensor of any of Embodiments 1-2 further comprising: a lens (131) between transparent portion of the enclosure and the IR sensor, wherein the lens is configured to focus the IR radiation incident on the IR sensor (122).

Embodiment 5. The chemical vapor sensor of any of Embodiments 1-4, further comprising: a shutter (121) between the transparent portion of the enclosure and the IR sensor, wherein the shutter (121) is coupled with the controller (133); wherein the controller (133) is configured to control the shutter (121) to modulate the IR radiation incident on the IR sensor (122).

Embodiment 6. The chemical vapor sensor of any of Embodiment 1-5, wherein the transparent portion of the enclosure has a hydrophilic surface.

Embodiment 7. A chemical vapor sensor configured to detect a chemical analyte, the chemical vapor sensor comprising: an enclosure (441) including first and second ports to an outside environment; a gas flow path (407, 405, 409) through the enclosure between the first and second ports, wherein the gas flow path includes an infrared (IR) transparent material; an internal IR standard (411) on a first side of the IR transparent material of the gas flow path, wherein the internal IR standard is configured to provide a stable IR background; an IR sensor (122) on a second side of the IR transparent material of the gas flow path, wherein the IR transparent material of the gas flow path is between the internal IR standard (411) and the IR sensor (122), wherein the IR transparent material of the gas flow path provides an IR transmission path through the gas flow path between the internal standard (411) and the IR sensor (122), and wherein the IR sensor is configured to generate signaling responsive to IR radiation incident thereon; and a controller (133) coupled with the IR sensor (122), wherein the controller (133) is configured to detect the presence of the chemical analyte in the gas cell (405) responsive to the signaling from the IR sensor.

Embodiment 8. The chemical vapor system of Embodiment 7, wherein the gas flow path comprises, an input vapor path (407) coupled with the outside environment through the first gas port, an output vapor path (409) coupled with the outside environment through the second gas port, and a gas cell (405) coupled between the input and output vapor paths (407 and 409), wherein the gas cell comprises the Infrared (IR) transparent material.

Embodiment 9. The chemical vapor sensor of any of Embodiments 7-8, further comprising: a lens (131) between the gas flow path and the IR sensor, wherein the lens is configured to focus the IR radiation incident on the IR sensor (122).

Embodiment 10. The chemical vapor sensor of any of Embodiments 7-9, further comprising: a shutter (121) between the gas flow path and the IR sensor, wherein the shutter (121) is coupled with the controller (133); wherein the controller (133) is configured to control the shutter (121) to modulate the IR radiation incident on the IR sensor (122).

Embodiment 11. The chemical vapor sensor of any of Embodiments 7-10, wherein the internal IR standard (411) comprises a high emissivity material (451) in a line of the IR transmission path between the internal IR standard and the IR sensor through the gas flow path.

Embodiment 12. The chemical vapor sensor of Embodiment 11, wherein the internal IR standard (411) comprises a thermoelectric (TE) cooler (453) thermally coupled between the high emissivity material (451) and a heat sink (455), wherein the controller (133) is configured to control the TE cooler (453) to thermoelectrically pump heat from the high emissivity material (451) to the heat sink.

Embodiment 13. The chemical vapor sensor of Embodiment 11, further comprising: a liquid cooler configured to cool the high emissivity material (455).

Embodiment 14. The chemical vapor sensor of Embodiment 13, wherein the liquid cooler is configured to cool the high emissivity material using liquid nitrogen.

Embodiment 15. The chemical vapor sensor of any of Embodiment 11-14, wherein the high emissivity material comprises at least one of a polymer and/or a metal.

Embodiment 16. A chemical vapor sensor configured to detect a chemical analyte, the chemical vapor sensor comprising: an enclosure (241) including a transparent portion, and wherein the transparent portion is transparent with respect to infrared (IR) radiation; an IR sensor (122) in the enclosure wherein the IR sensor is oriented to receive IR radiation incident thereon through the transparent portion of the enclosure, and wherein the IR sensor is configured to generate signaling responsive to the IR radiation incident thereon; and a controller (133) coupled with the IR sensor (122), wherein the controller (133) is configured to detect the presence of the chemical analyte outside the enclosure responsive to the signaling from the IR sensor.

Embodiment 17. The chemical vapor sensor of Embodiment 16, wherein the enclosure includes a convex surface (301) having an apex, and wherein the transparent portion of the enclosure is provided at the apex of the convex surface.

Embodiment 18. The chemical vapor sensor of any of Embodiments 16-17, wherein the transparent portion of the enclosure comprises a lens configured to focus the IR radiation incident on the IR sensor.

Embodiment 19. The chemical vapor sensor of any of Embodiments 16-18 further comprising: a lens (131) between transparent portion of the enclosure and the IR sensor, wherein the lens is configured to focus the IR radiation incident on the IR sensor.

Embodiment 20. The chemical vapor sensor of any of Embodiments 16-19, further comprising: a shutter (121) between the transparent portion of the enclosure and the IR sensor (122), wherein the shutter is coupled with the controller; wherein the controller is configured to control the shutter to modulate the IR radiation incident on the IR sensor.

Complete citations are provided below for the publications cited in the foregoing disclosure, and the disclosures of these publications are hereby incorporated herein in their entirety by reference.

Reference 1. MAJOR, K., et al., U.S. Patent No. 11,029,247, “Infrared CIE methodology for chemical group classification,” (Issued June 8, 2021).

Reference 2. POUTOUS, M. K., et al., U.S. Patent No. 9,857,295, “Comparative discrimination spectral detection system and method for the identification of chemicals with overlapping spectral signatures,” (Issued January 2, 2018).

Reference 3. MAJOR, K. J., et al., "Demonstration of a Human Color Vision Mimic in the Infrared", Analytical Chemistry, Vol. 91, Issue 21, pages 14058-14065 (2019).

Reference 4. MAJOR, K. J., et al., "Optical Filter Selection for High Confidence Discrimination of Strongly Overlapping Infrared Chemical Spectra", Analytical Chemistry, Vol. 87, Issue 17, pages 8798-8808, August 4, 2015).

Reference 5. POUTOUS, M. K., et al., "Comparative Discrimination Spectral Detection Method for the Identification of Vapors Using Overlapping Broad Spectral Filters," Applied Spectroscopy, Vol. 69, Issue 3, pages 305-313, (2015).

Reference 6. MCGINNIS, C.L., et al., “Biomimetic Optical-Filter Sensor System for Discrimination of Infrared Chemical Signatures Against a Cold Sky Background”, Applied Spectroscopy, Vol. 79, Issue 2, pages 260-264, June 11, 2024.

Reference 7. McGinnis, C.L., et al., U.S. Patent Application No. 63/734,308, “Manufactured Controllable Cold Background for Passive Biomimetic Sensor,” filed December 16, 2024.

Reference 8. McGinnis, C.L., et al., U.S. Patent Application No. 19/390,826, “Manufactured Controllable Cold Background for Passive Biomimetic Sensor,” filed November 17, 2025.

Reference 9. McGinnis, C.L., et al., International PCT Application No. PCT/US25/59112, filed December 11, 2025.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term "and/or" includes any and all combinations of one or more of the associated listed items.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present inventive concepts.

It will also be understood that when an element is referred to as being on or connected to/with or coupled to/with another element, it can be directly on or connected to/with or coupled to/with the other element, or intervening elements may be present. In contrast, when an element is referred to as being directly on or directly connected to/with or directly coupled to/with another element, there are no intervening elements present. Moreover, if an element is referred to as being “on” another element, no spatial orientation is implied such that the element can be over the other element, under the other element, on a side of the other element, etc.

Embodiments are described herein with reference to plan, cross-sectional, and/or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region/element of a device and are not intended to limit the scope of the present inventive concepts.

Unless otherwise defined, all terms (including technical and scientific terms) used herein have the same meaning as commonly understood by one of ordinary skill in the art to which the inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While inventive concepts have been particularly shown and described with reference to examples of embodiments thereof, it will be understood that various changes in form and details may be made therein without departing from the spirit of the following claims.

1. A chemical vapor sensor configured to detect a chemical analyte, the chemical vapor sensor comprising:
an enclosure configured so that a top of the enclosure is oriented up when the chemical vapor sensor is in use, and wherein the top of the enclosure includes a transparent portion, and wherein the transparent portion is transparent with respect to infrared radiation;
an infrared (IR) sensor in the enclosure wherein the IR sensor is oriented up when the chemical vapor sensor is in use to receive IR radiation incident thereon through the transparent portion of the top of the enclosure, and wherein the IR sensor is configured to generate signaling responsive to the IR radiation incident thereon; and
a controller coupled with the IR sensor, wherein the controller is configured to detect the presence of the chemical analyte outside the enclosure responsive to the signaling from the IR sensor.

2. The chemical vapor sensor of claim 1, wherein the top of the enclosure includes a convex surface having an apex, and wherein the transparent portion of the enclosure is provided at the apex of the convex surface.

3. The chemical vapor sensor of claim 1, wherein the transparent portion of the enclosure comprises a lens configured to focus the IR radiation incident on the IR sensor.

4. The chemical vapor sensor of claim 1 further comprising:
a lens between transparent portion of the enclosure and the IR sensor, wherein the lens is configured to focus the IR radiation incident on the IR sensor.

5. The chemical vapor sensor of claim 1, further comprising:
a shutter between the transparent portion of the enclosure and the IR sensor, wherein the shutter is coupled with the controller;
wherein the controller is configured to control the shutter to modulate the IR radiation incident on the IR sensor.

6. The chemical vapor sensor of claim 1, wherein the transparent portion of the enclosure has a hydrophilic surface.

7. A chemical vapor sensor configured to detect a chemical analyte, the chemical vapor sensor comprising:
an enclosure including first and second ports to an outside environment;
a gas flow path through the enclosure between the first and second ports, wherein the gas flow path includes an infrared (IR) transparent material;
an internal IR standard on a first side of the IR transparent material of the gas flow path, wherein the internal IR standard is configured to provide a stable IR background;
an IR sensor on a second side of the IR transparent material of the gas flow path, wherein the IR transparent material of the gas flow path is between the internal IR standard and the IR sensor, wherein the IR transparent material of the gas flow path provides an IR transmission path through the gas flow path between the internal standard and the IR sensor, and wherein the IR sensor is configured to generate signaling responsive to IR radiation incident thereon; and
a controller coupled with the IR sensor, wherein the controller is configured to detect the presence of the chemical analyte in the gas cell responsive to the signaling from the IR sensor.

8. The chemical vapor system of claim 7, wherein the gas flow path comprises,
an input vapor path coupled with the outside environment through the first gas port,
an output vapor path coupled with the outside environment through the second gas port, and
a gas cell coupled between the input and output vapor paths, wherein the gas cell comprises the Infrared (IR) transparent material.

9. The chemical vapor sensor of claim 7, further comprising:
a lens between the gas flow path and the IR sensor, wherein the lens is configured to focus the IR radiation incident on the IR sensor.

10. The chemical vapor sensor of claim 7, further comprising:
a shutter between the gas flow path and the IR sensor, wherein the shutter is coupled with the controller;
wherein the controller is configured to control the shutter to modulate the IR radiation incident on the IR sensor.

11. The chemical vapor sensor of claim 7, wherein the internal IR standard comprises a high emissivity material in a line of the IR transmission path between the internal IR standard and the IR sensor through the gas flow path.

12. The chemical vapor sensor of claim 11, wherein the internal IR standard comprises a thermoelectric (TE) cooler thermally coupled between the high emissivity material and a heat sink, wherein the controller is configured to control the TE cooler to thermoelectrically pump heat from the high emissivity material to the heat sink.

13. The chemical vapor sensor of claim 11, further comprising:
a liquid cooler configured to cool the high emissivity material.

14. The chemical vapor sensor of claim 13, wherein the liquid cooler is configured to cool the high emissivity material using liquid nitrogen.

15. The chemical vapor sensor of claim 11, wherein the high emissivity material comprises at least one of a polymer and/or a metal.

16. A chemical vapor sensor configured to detect a chemical analyte, the chemical vapor sensor comprising:
an enclosure including a transparent portion, and wherein the transparent portion is transparent with respect to infrared radiation;
an infrared (IR) sensor in the enclosure wherein the IR sensor is oriented to receive IR radiation incident thereon through the transparent portion of the enclosure, and wherein the IR sensor is configured to generate signaling responsive to the IR radiation incident thereon; and
a controller (133) coupled with the IR sensor (122), wherein the controller (133) is configured to detect the presence of the chemical analyte outside the enclosure responsive to the signaling from the IR sensor.

17. The chemical vapor sensor of claim 16, wherein the enclosure includes a convex surface having an apex, and wherein the transparent portion of the enclosure is provided at the apex of the convex surface.

18. The chemical vapor sensor of claim 16, wherein the transparent portion of the enclosure comprises a lens configured to focus the IR radiation incident on the IR sensor.

19. The chemical vapor sensor of claim 16 further comprising:
a lens between transparent portion of the enclosure and the IR sensor, wherein the lens is configured to focus the IR radiation incident on the IR sensor.

20. The chemical vapor sensor of claim 16, further comprising:
a shutter between the transparent portion of the enclosure and the IR sensor, wherein the shutter is coupled with the controller;
wherein the controller is configured to control the shutter to modulate the IR radiation incident on the IR sensor.
